(19) United States
(12) Patent Application Publication
(10) Pub. No.: US 2005/0286708 A1
(43) Pub. Date: Dec. 29, 2005

(54) Advanced call center call recording, compression, storage, and retrieval method and system

(76) Inventors: Jared Alan Slosberg, Austin, TX (US); Joshua Ryan Garvin, Austin, TX (US)

Correspondence Address: WHITE-WELKER & WELKER, LLC, P.O. BOX 199, CLEAR SPRING, MD, 21722-0199, US

(21) Appl. No.: 10/878,768

(22) Filed: Jun. 28, 2004

(51) Int. Cl. H04M 3/00; H04M 1/64

(52) U.S. Cl. 379/265.07; 379/85

(57) ABSTRACT

The computer calling system disclosed enables the automated recording of voice telephone conversations in a centralized or distributed call center environment. The automated recording system is novel in that it records telephone calls locally and transfers them to a central server that provides centralized access and tracking. Voice files are recorded on the agent side of the telephone call that provides for all processing on the agents computer. Processing may include the compression of the voice file. Voice files are tracked in a centralized database and transferred to and stored on a centralized server for easier retrieval and review by a third party from a remote computer system.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### TECHNICAL FIELD OF THE INVENTION

The present invention relates generally to call centers and more specifically to the agent side recording, saving, storing and compression of recorded voice communications that are easily located and retrieved from a centralized database system.

### BACKGROUND OF THE INVENTION

Computer calling systems designed to automatically dial a customer telephone number and determine when a person answers the call are well known in the prior art. Once a customer answers the automated call, an agent is then connected to the customer via the calling system. Agents typically initiate a conversation by first reading from a prepared script and enter information solicited from the customer into their computer terminal for storage in the calling system.

Such calling systems are well known in the prior art and are often used for a variety of purposes such as marketing solicitations, poll taking, surveys, debt collection, sales, or any other calling campaign. A “customer” is any person receiving a telephone call for purposes of any particular organized telephone campaign.

For a variety of business and legal considerations it is often desirable to monitor, record, and store entire or partial conversations between a customer and an agent. Recording can help to verify the accuracy of information entered into the calling system by the agent, correct errors to the entered data, prevent and deter agent and customer fraud, monitor agent performance or demeanor, train agents, and to defend against any claims or legal actions raised by a customer.

Agent-side recording systems currently known and utilized in prior art calling systems for the monitoring and recording of communications between agents and customers are very inefficient and difficult for an agent to utilize and for managers to use to locate and retrieve recorded calls for later review. One reason is that the call recording equipments is typically separated from the centralized computer system which is used to log phone calls and retain data regarding each individual customer such as telephone number, name, address and ordering information. During a call this separation places an additional burden on the agent who must utilize a different system to record calls, store the electronic data file, and name it for later identification and retrieval. Additionally, upon completion of the call, customer data records and the voice file must be stored and accurately labeled for later retrieval or matching to establish the proper correlation between the records. It is time consuming and inefficient for a manager or quality control agent to verify the information entered by a calling agent because of the system separation between the customer information data and the voice data files.

For example, in some prior art systems the calling agent is provided with a tape recorder that is connected into the telephone line. At an appropriate point in time the calling agent must manually start the tape recorder. At the same time the agent must continue the customer conversation which may require the entrance of customer information such as telephone number, address, billing information, or ordering information into the customer database system. At the end of the customer conversation, the calling agent must stop the tape manually after the desired voice recording is complete. Upon the end of an agent's shift this tape will contain numerous customer communications that are not tied to the customer information that was entered into the centralized customer database system.

In more recent and improved systems of the prior art, the recording of customer conversations has been automated to eliminate the need for a calling agent to use a tape recording device. In these systems a separate system is used to control the recording process which is typically in the form of separate software running on a calling agent's computer that enables the calling agent to start and stop conversation recording. This separate system does not solve the problem of the lack of correlation between the customer information which is stored on a centralized customer database system and the recorded customer communications which are stored on each individual agent's computer. In order to listen to a recorded customer communication, a manager or quality control agent must first look up the customer information in the centralized customer database system and identify the agent who made the call, as well as the date and time of the call. The manager or quality control agent must then physically or electronically access the agent's computer to look up the call by date and time. This is very awkward and time-consuming.

These systems contain many deficiencies such as not providing a standard file naming methodology for the voice-recording file to enable correlation to the client information file at a later time or to facilitate easier retrieval from the voice communication database system. Additionally, the agent-side recording systems of the prior art require that the actual recording be done on the agent side of the telephone conversation, which does not enable easy correlation between the voice recording and the customer information file.

As discussed, subsequent verification of the entered customer data using the voice recordings is cumbersome due to the poor naming, correlation to customer data files, and database retrieval. Without a predetermined voice recording file process and agent side tracking of the file for correlation between the voice recording file and customer data file, to verify a particular customer transaction one must either find the appropriate tape (in a manual system) or located the appropriate voice file (in an more automated system). Thus, a verifier may have to sift through numerous conversations on either tapes or electronic files to find the relevant conversation. Due to fact that both prior art systems require substantial human interaction, low productivity, human errors, and the loss of information are inevitable.

Thus, although the prior art systems provide substantial automation of many aspects of calling systems, such systems will still suffer from deficiencies and inefficiencies due to the remote recording of customer communications and records management problems.

Centralized recording systems currently known and utilized in prior art calling systems for the monitoring and recording of communications between agents and customers are often able to overcome many of the disadvantages of agent-side recording systems. Since they are centralized, all recordings are stored in the same place and a manager or quality control agent can easily access them without going from agent computer to agent computer. Additionally, many centralized recording systems can interface well with customer information databases so that a manager or quality control agent can view customer information and listen to customer communications simultaneously.

Centralized recording systems have one inherent limitation: all calls must pass through the centralized recording system. This is not a tremendous problem if all of the agents are physically located in the same building since the centralized recording system can be attached to the telephone switch that serves all of the agents. However, if the agents are geographically distributed, all of their calls must first be routed to the centralized recording system and then routed to the customer.

Routing calls through a centralized recording system has two principal disadvantages. First, it is expensive. At a minimum, one must pay for two telephone calls (from the agent to the centralized recording system and from the centralized recording system to the customer) instead of one (from the agent to the customer). Second, it is less reliable. If there is a problem with the centralized recording system or the telecommunications infrastructure where the centralized recording system is located (such as a major snow storm), no agent can continue calling. By distributing the recording system, problems with one recording system or in one geographical location do not affect other agents.

### SUMMARY OF THE INVENTION

The present invention provides an automated computer calling system that overcomes the drawbacks of both the client-side recording systems and centralized recording systems described in the prior art. In addition, the present invention provides a method for recording customer voice communications from the agent side, while naming recorded customer voice communication files and tracking their movement to a centralized database. The calling system of the present invention is also capable of compressing the files on a local agent computer system before transfer to a centralized database.

In the preferred embodiment, the calling system of the present invention can optionally include file compression on the calling agent's local computer system for the reduction of file transfer size and to increase file transfer speeds.

The present invention utilizes a call center structure with multiple telephone agents working either at the same location or at disparate locations, each with their own local computer, dialing and recording device, standard telephone lines, and local Internet access or other wide area network access.

Initially a calling agent connects and logs in to the centralized database over the Internet or other wide area network access point, identifying and authenticating themselves. Next the calling agent is assigned a customer record their local computer system will dial the telephone number found in the record. In the preferred embodiment, the calling agent connects to a standard telephone line. In another embodiment, the agent connects over the Internet to a remote phone switch using a commercially available Voice over IP interface. The automated dialing is triggered by an active control feature on the calling agent's machine that controls the dialing device of the calling agent's local machine and causes it to dial the selected telephone number. In the preferred embodiment, the dialing device is a hardware device that interfaces the computer to a standard telephone line or to a second hardware device that connects to a telephone switch over the Internet. In another embodiment, the dialing device is software running on the agent's local machine that connects, either directly or through another piece of software running on the agent's local machine, to a telephone switch over the Internet.

Once the installed dialing device on the calling agent's local computer detects an answer to the phone call, it communicates it to the active control, which automatically starts the recording. At the end of the conversation, the dialing device detects the hang-up and communicates it to the active control device, which stops the recording.

Upon call completion, a file name with a unique identifier is generated and stored in the centralized database to provide easier tracking, retrieval of the recording, and matching to customer files. In one embodiment, the file name is provided by the centralized database based on the combination of the agent's identification number and the date and time of the call. In other embodiments, the unique identifier is generated by the local agent machine and transferred to the centralized database.

A separate software process running on the agent machine detects that a new recording has been written. It then compresses the file and transfers it via FTP or other files transfer protocol to a centralized server. In the preferred embodiment the separate software process of the present invention uses GSM compression on standard .wav files. Other compression processes and audio files types such as MP3 and Real Voice have tried been tried in combination with several different compression algorithms, but the present invention has found the best mode of operation with respect to the size and quality of the recording is GSM compression on standard .wav files. One of ordinary skill in the art will appreciate that any combination of compression algorithms and voice file types could be used in the present invention in addition to new compression techniques or file types without deviating from the scope of the present invention.

Because the file name of the recording file was logged by the database, anyone with access to the centralized database can look up the name of the file and access it. In the present embodiment, the centralized database can be accessed via a browser or other GUI system. By clicking on a button, the user can instruct the centralized database to redirect the user to the recording file, which starts streaming like any other .wav file via the browser or comparable GUI system.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the major elements required for the call center of the present invention;

FIG. 2 illustrates the hardware and software requirements for the call center of the present invention;

FIG. 3 illustrates the calling, recording, and storing process of the call center of the present invention;

FIG. 4 illustrates the hardware and software interactions for recording, naming, compressing, and storing a recorded voice communication;

FIG. 5 illustrates the separate steps for the process of automatically detecting that a new call and voice recording has been created and the compression, naming, and transfer of the recording file from the calling agents computer to a centralized database.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

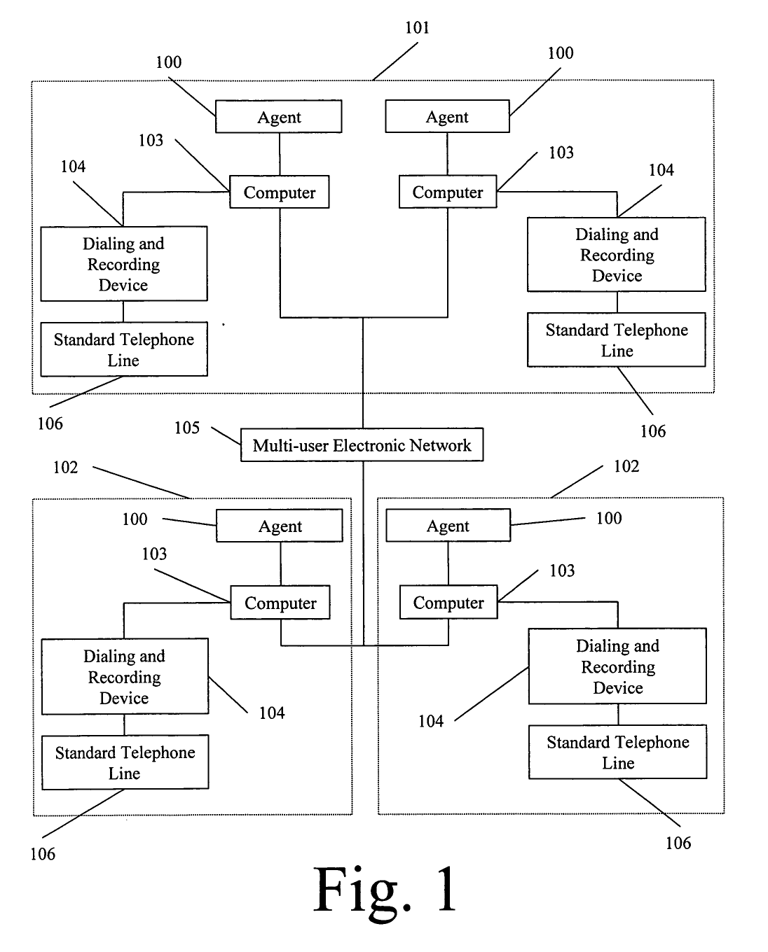

Referring to the figures, it is possible to see the various major elements constituting the apparatus of the present invention. The invention is an improved recording system and method which enables agent side call recording and tracking and recording of created voice recording files to a centralized database for later retrieval and review. The major elements, as illustrated in FIG. 1, consist of multiple telephone agents (100) working either at the same location (101) or at disparate locations (102), each with their own computer and software systems (103), dialing and recording device (104), a multi-user electronic network such as the Internet access (105), and standard telephone lines (106).

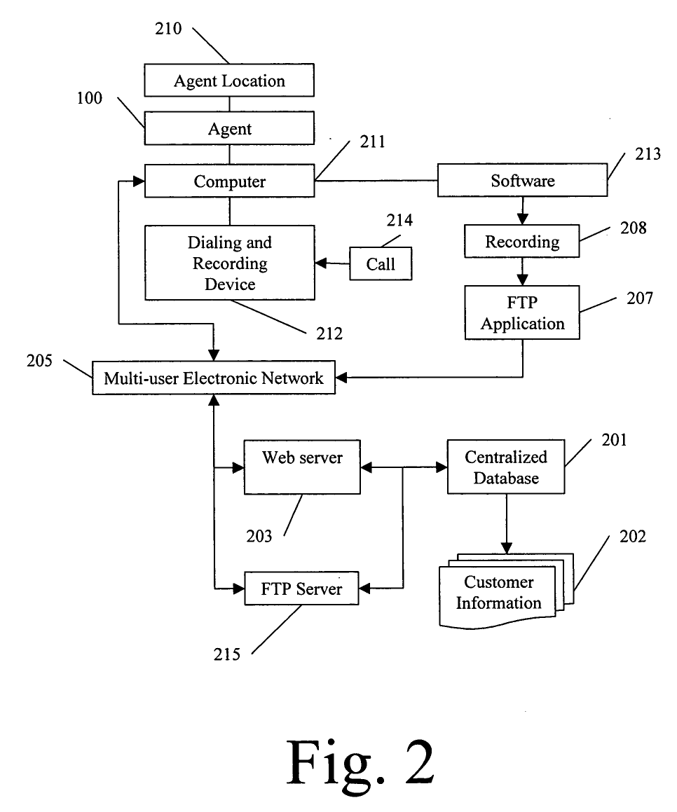

Now referring to FIG. 2, the hardware and software requirements of the calling center of the present invention are illustrated. At each agent location (210) a standard personal computer (211) is provided. Each personal computer (211) contains a dialing and recording device (212) and FTP application software (207). In the preferred embodiment of the present invention Hi-Phone by Way2Call is utilized, but it should be appreciated by one of ordinary skill in the art that any dialing and recording device of equivalent function could be used in the present invention.

At each agent location (210), upon the receipt of a call or a calling agent initiated call (214), software (213) that records, compresses, and uploads recordings automatically records the entire voice communication. FTP server (215) or other technology allows calling agents (100) to upload their recordings (208) to the centralized database (201).

At the core of the agent side recording system of the present invention is a centralized database (201) that stores information about the customers (202) that are being called by a calling agent or that are calling in to the call center. Such centralized databases (201) typically use Microsoft SQL server or Oracle software, but it should be appreciated by one of ordinary skill in the art that any database software of equivalent function could be used in the present invention. Web server or other technology (203) that allows remote calling agents (100) to access the centralized database (201) over a wide area network (205) such as the Internet from their local computer (211) is utilized to enable remote calling agents (100) to access the necessary customer information (202). In a preferred embodiment of the present invention Microsoft IIS runs on a centrally located server. Microsoft Internet Explorer is utilized on the client's machine to access Microsoft IIS on the server. Again, it should be appreciated by one of ordinary skill in the art that any server or browser system of equivalent function could be used in the present invention.

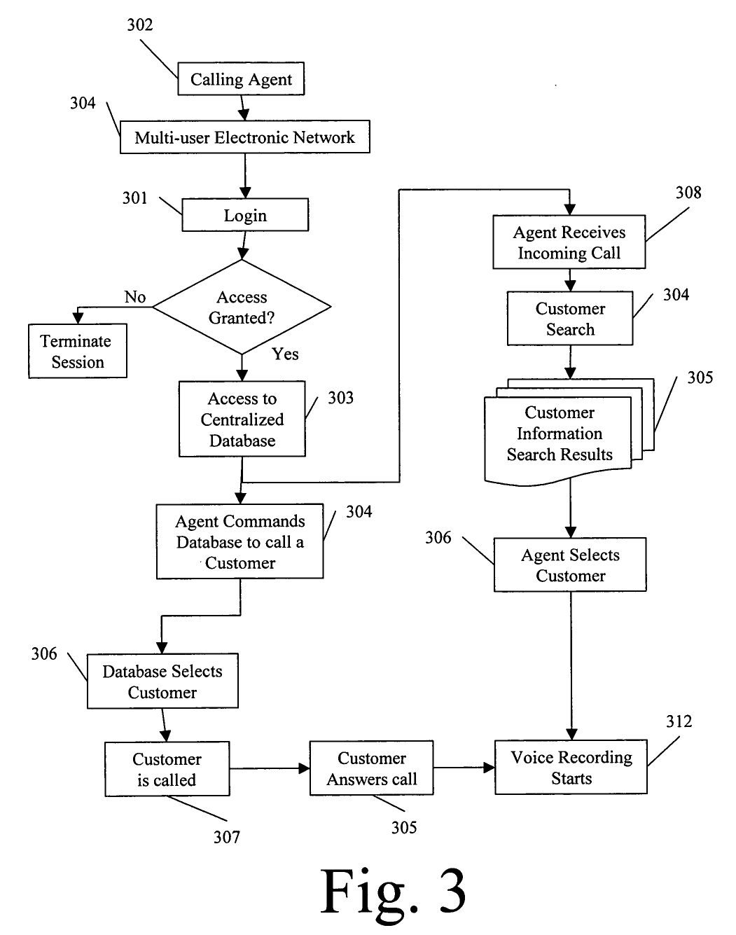

Now referring to FIG. 3, the process for the advanced agent side recording system of the present invention is illustrated. In step 301, a calling agent (302) connects and logs in to the centralized database (303) over the web or other computer network (304). In step 302 access is granted upon the calling agents identifying and authenticating themselves to the centralized database (303). In step 304, the agent commands the centralized database (303) to call a customer and upon the centralized database's (303) selection of the customer in Step 306, the hardware dialing device dials the customer's telephone number saved in the record file and the customer is called (307). Upon the customers answering of the call in Step 305 recording is initiated. Alternatively, following step 308, a calling agent (302) can accept inbound calls by picking up the phone and then finding the customer's record (310). Once the customer record is located in step 311, the voice recording commences (312). On inbound calls, the recording starts when the customer record is located since the customer is already on the line. On outgoing calls, the recording starts when the call is answered.

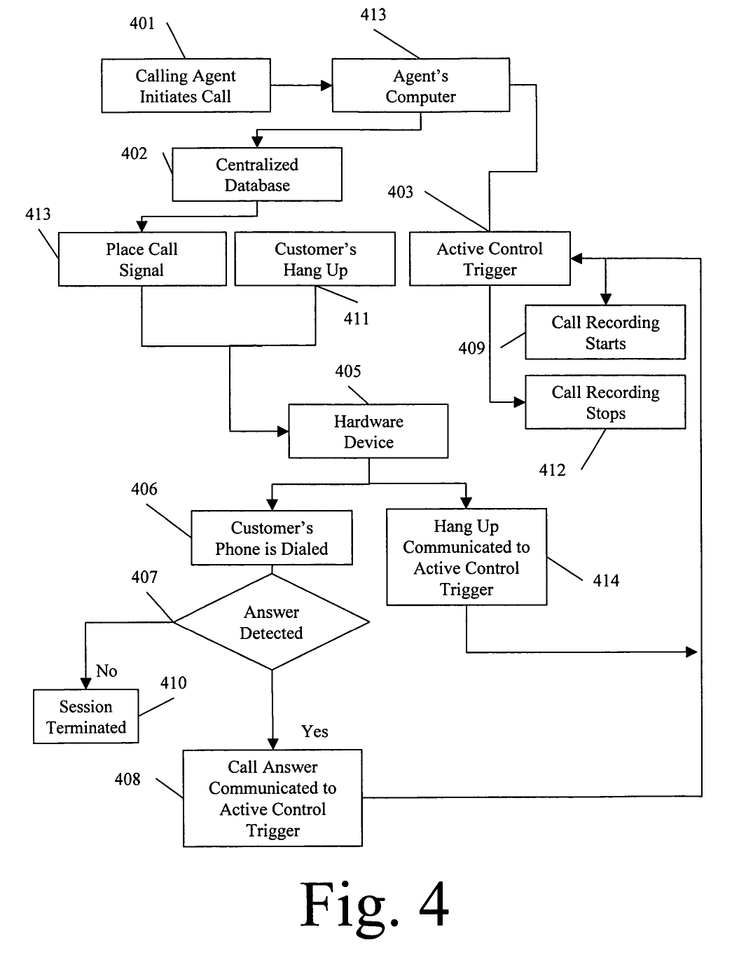

Now referring to FIG. 4 the hardware and software interactions for recording, naming, compressing, and storing a recorded voice communication are illustrated. Upon a calling agent's initiation of a call (401) from their computer (413), the centralized database (402) communicates to an active control trigger (403) on an agent's computer (413) that controls the dialing device (405) and causes it to dial the customer's telephone number (406) and place a call (413). In step 407, if the dialing device (405) detects a call answer and communicates it (408) to the active control trigger (403), which starts the recording (409). If no answer is detected the call session terminates (410) and the dialing device (405) and active control trigger (403) wait for their next commands. At the end of the conversation, the dialing device (405) detects the hang-up (411) and communicates (414) it to the active control trigger (403) that stops the recording (412).

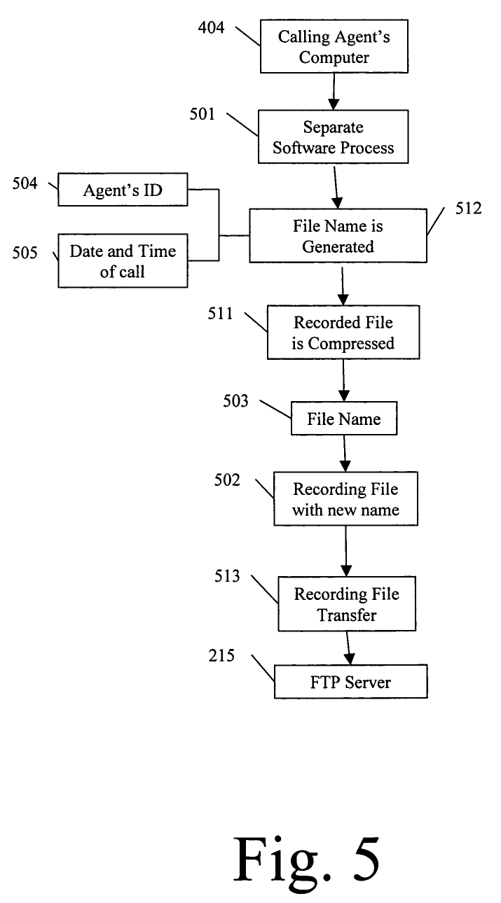

Now referring to FIG. 5, in step 510 a separate software process (501) running on the calling agent's computer (404) detects that a new recording has been created. The software (501) then, in step 511 the software compresses the recording file (502). In step 512 a file name (503) is assigned to the recording file (502), provided by the centralized database (402). In the preferred embodiment of the present invention, the file name (503) is made unique through a combination of the calling agent's identification number (504) and the date and time of the call (505). In step 513 the software transfers the recording file (502) to the centralized database (402) via FTP or other file transfer means.

Because the file name (503) of the recording file (502) was provided and logged by the centralized database (402), one can access the centralized database (402) using any web-based or enabled browser from any location, search for and retrieve a unique call, and select the recording file (502) or file name (503) to hear the recording. The centralized database (402) redirects the connected user to the recording file (502), which starts streaming to the user like any other .wav file currently known in the art of web-based or enabled browsers.

In the preferred embodiment of the present invention GSM compression on standard .wav files is used. Several different compression algorithms have been tested and it has been found that GSM compression on standard .wav files provides the best combination with respect to file size and sound quality. It should be appreciated by one of ordinary skill in the art that any combination of compression algorithm and sound file of equivalent functions could be used in the present invention.

The present invention provides an automated computer calling system that overcomes the drawbacks of both the client-side recording systems and centralized recording systems described in the prior art. In addition, the present invention provides a method for recording customer voice communications from the agent side, while naming recorded customer voice communication files and tracking their movement to a centralized database. The calling system of the present invention is also capable of compressing the files on a local agent computer system before transfer to a centralized database.

In the preferred embodiment, the calling system of the present invention can optionally include file compression on the calling agent's local computer system for the reduction of file transfer size and to increase file transfer speeds.

The present invention utilizes a call center structure with multiple telephone agents working either at the same location or at disparate locations, each with their own local computer, dialing and recording device, standard telephone lines, and local Internet access or other wide area network access.

Initially a calling agent connects and logs in to the centralized database over the Internet or other wide area network access point, identifying and authenticating themselves. Next the calling agent is assigned a customer record their local computer system will dial the telephone number found in the record. In the preferred embodiment, the calling agent connects to a standard telephone line. In another embodiment, the agent connects over the Internet to a remote phone switch using a commercially available Voice over IP interface. The automated dialing is triggered by an active control feature on the calling agent's machine that controls the dialing device of the calling agent's local machine and causes it to dial the selected telephone number.

Once the installed dialing device on the calling agent's local computer detects an answer to the phone call, it communicates it to the active control, which automatically starts the recording. At the end of the conversation, the dialing device detects the hang-up and communicates it to the active control device, which stops the recording.

Upon call completion, a file name with a unique identifier is generated and stored in the centralized database to provide easier tracking, retrieval of the recording, and matching to customer files. In one embodiment, the file name is provided by the centralized database based on the combination of the agent's identification number and the date and time of the call. In other embodiments, the unique identifier is generated by the local agent machine and transferred to the centralized database.

A separate software process running on the agent machine detects that a new recording has been written. It then compresses the file and transfers it via FTP or other files transfer protocol to a centralized server. In the preferred embodiment the separate software process of the present invention uses GSM compression on standard .wav files. Other compression processes and audio files types such as MP3 and Real Voice have tried been tried in combination with several different compression algorithms, but the present invention has found the best mode of operation with respect to the size and quality of the recording is GSM compression on standard .wav files. One of ordinary skill in the art will appreciate that any combination of compression algorithms and voice file types could be used in the present invention in addition to new compression techniques or file types without deviating from the scope of the present invention.

Because the file name of the recording file was logged by the database, anyone with access to the centralized database can look up the name of the file and access it. In the present embodiment, the centralized database can be accessed via a browser or other GUI system. By clicking on a button, the user can instruct the centralized database to redirect the user to the recording file, which starts streaming like any other .wav file via the browser or comparable GUI system.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Additionally, further automation of the voice communication recording, name, and storage is considered to be within the scope of the invention.

Furthermore, other areas of art may benefit from this method and adjustments to the design are anticipated. Thus, the scope of the invention should be determined by the appended claims and their legal equivalents, rather than by the examples given.

1. Method for hearing and recording telephone calls comprising:
one or more agents operating at one or more agent stations recording and encoding telephone conversations;
said agent stations including a dialing device;
file name identifiers for encoded audio file stored by a centralized database;
listening station for retrieval of said encoded audio files.

2. The method for hearing and recording telephone calls of claim 1 wherein said agent station transfers encoded audio files to a centralized storage means.

3. The method for hearing and recording telephone calls of claim 1 wherein said agent stations compress the recording data file.

4. The method for hearing and recording telephone calls of claims 1, 2, and 3 wherein said file name identified or by a centralized computer.

5. The method for hearing and recording telephone calls of claim 1 wherein the dialing device is a hardware device that interfaces the computer to a standard telephone line or to a second hardware device that connects to a telephone switch over the Internet.

6. The method for hearing and recording telephone calls of claim 1 wherein the dialing device is software running on the agent's local machine that connects, either directly or through another piece of software running on the agent's local machine, to a telephone switch over the Internet.

7. System and method for hearing and recording calls comprising:
one or more agents located at agent stations;
said agent stations comprising data connection to computer network, telecommunication means, dialing device, call recording means, audio encoding means, and data transfer means;
said agent stations recording and encoding conversations from said telecommunication means;
file name identifiers for encoded audio files stored by a centralized database; and
a listening station comprising a data connection to said computer network and audio decoding means.

8. The system and method for hearing and recording telephone calls of claim 7 wherein said agent stations compress said audio files.

9. The system and method for hearing and recording telephone calls of claims 7 and 8 wherein said file name identifiers are provided by a centralized computer.

10. The system and method for hearing and recording telephone calls of claim 7 wherein said agent stations transfer encoded audio files to a centralized storage means.

11. The method for hearing and recording telephone calls of claim 7 wherein the dialing device is a hardware device that interfaces the computer to a standard telephone line or to a second hardware device that connects to a telephone switch over the Internet.

12. The method for hearing and recording telephone calls of claim 7 wherein the dialing device is software running on the agent's local machine that connects, either directly or through another piece of software running on the agent's local machine, to a telephone switch over the Internet.

13. System for hearing and recoding telephone calls from agent stations comprising:
a telephone line;
data connection to a computer network;
dialing device;
call recording means;
audio encoding means;
data transfer means;
centralized database for storage and retrieval of encoded audio files;
listening station with a data connection to said computer network and audio decoding means.

14. The system for hearing and recoding telephone calls from agent stations of claim 13 wherein said agent station provides means for the compression of said audio files.

15. The system for hearing and recording telephone calls of claim 14 wherein said file name identifiers are provided by a centralized computer.

16. The system and method for hearing and recording telephone calls of claims 13, 14 and 15 wherein said agent stations transfer encoded audio files to a centralized storage means.

17. The system for hearing and recording telephone calls of claim 14 wherein the dialing device is a hardware device that interfaces the computer to a standard telephone line or to a second hardware device that connects to a telephone switch over the Internet.

18. The system for hearing and recording telephone calls of claim 14 wherein the dialing device is software running on the agent's local machine that connects, either directly or through another piece of software running on the agent's local machine, to a telephone switch over the Internet.
